(19) United States
(12) Patent Application Publication
(10) Pub. No.: US 2021/0040984 A1
(43) Pub. Date: Feb. 11, 2021

(54) CRANKSHAFT

(71) Applicant: NIPPON STEEL CORPORATION, Tokyo (JP)

(72) Inventors: Yukihiko KIMURA, Chiyoda-ku, Tokyo (JP); Kenji TAMURA, Chiyoda-ku, Tokyo (JP); Hiroshi NOGAMI, Chiyoda-ku, Tokyo (JP); Sam Soo HWANG, Chiyoda-ku, Tokyo (JP); Kunihiro YABUNO, Chiyoda-ku, Tokyo (JP)

(21) Appl. No.: 16/965,128

(22) PCT Filed: Jan. 17, 2019
(86) PCT No.: PCT/JP2019/001356

§ 371 Date: Jul. 27, 2020

(30) Foreign Application Priority Data
Jan. 30, 2018 (JP) 2018-013309

(51) Int. Cl. F16C 3/08

(52) U.S. Cl. CPC F16C 3/08; F02F 7/0053

(57) ABSTRACT

A crankshaft includes a plurality of journals, a plurality of pins, and a plurality of crank arms. The journals are coaxially disposed with the rotational center of the crankshaft. The pins are decentered with respect to the journals. Each of the crank arms is disposed between one journal and one pin to join the one journal with the one pin. One or more of the crank arms integrally include a counterweight. The counterweight includes two side surfaces. The side surfaces are each provided with a quenched layer.

### TECHNICAL FIELD

The present disclosure relates to a crankshaft to be mounted on a reciprocating engine for an automobile, a motor cycle, an agricultural machine, or a ship, etc.

### BACKGROUND ART

A reciprocating engine requires a crankshaft. This is for deriving power by transforming reciprocating movement of a piston in a cylinder into rotational movement. Generally, a multi-cylinder engine is used for automobiles and others.

FIGS. 1 and 2 are side views to show an example of a typical crankshaft. The crankshaft 1 shown in FIGS. 1 and 2 is to be mounted on a four-cylinder engine. The crankshaft 1 includes five journals J1 to J5, four pins P1 to P4, a front part Fr, a flange part F1, and eight crank arms (hereinafter also referred to as “arms”) A1 to A8. The eight arms A1 to A8 are each disposed between one of the journals J1 to J5 and one of the pins P1 to P4, and each arm joins the journal with the pin, with which the arm itself faces.

In the crankshaft 1 shown in FIG. 1, all the eight arms A1 to A8 integrally include counterweights (hereinafter, may he simply referred to as “weights”) W1 to W8, respectively. This crankshaft 1 is referred to as a crankshaft of 4-cylinder 8-counterweight.

Hereinafter, when collectively referring to the journals J1 to J5, the pins P1 to P4, the arms A1 to A8, and the weights W1 to W8, respectively, their symbols are also denoted as “J” for the journals, “P” for the pins. “A” for the aims, and “W” lb the weights.

In the crankshaft 1 shown in FIG. 2, among the eight arms A, the front-most first arm A1, the rear-most eighth arm A8, and the fourth arm A4 and the fifth arm A5 in the middle integrally include a weight W, respectively. The remaining anus A2, A3, A6 and A7 has no weight. This crankshaft 1 is referred to as a crankshaft of 4-cylinder 4-counterweight.

The journals 1, the front part Fr and the flange part F1 are disposed coaxially with the rotational center of the crankshaft 1. Each pin P is disposed so as to be decentered from the rotational center of the crankshaft 1 by a distance of a half of the piston stroke. The Journals 1 are supported on an engine block via sliding bearings, and serve as a rotating shaft. Each pin P is connected to a large end of a connecting rod (hereinafter also referred to as a “con-rod”) via a sliding bearing, and a piston is connected to a small end of the con-rod. A pulley (not shown) for driving a timing belt, a fan belt, and the like is attached to the front part Fr. A flywheel (not shown) is attached to the flange part F1.

In a reciprocating engine, suppression of vibration is a crucial task. This is because the vibration of a reciprocating engine causes noise, thereby aggravating the environment around the reciprocating engine. Particularly, in a vehicle such as an automobile mounted with a reciprocating engine, since a comfortable interior environment is required, the suppression of vibration is highly demanded. Here, the crankshaft is a heavy part that rotates in the reciprocating engine Therefore, the vibration suppression of the crankshaft will significantly contribute to the vibration suppression of the reciprocating engine.

To achieve the vibration suppression of the crankshaft, conventionally the following two strategies have been taken. The first strategy is to optimize the structure of the sliding bearing that supports the journal of the crankshaft. The second strategy is to provide vibration damping function to attachment components to be attached to the crankshaft. As the first strategy, Japanese Patent Application Publication No. 2016-153658 (Patent Literature 1) discloses a technique of improving vibration characteristics by appropriately setting a clearance between the journal and the sliding bearing. As the second strategy, Japanese Patent Application Publication No. 2005-299807 (Patent Literature 2) discloses a technique of causing bending vibration and twisting vibration to be damped by attaching, a damper pulley (crankshaft pully) to the front part of the crankshaft.

### CITATION LIST

### PATENT LITERATURE

Patent Literature 1: Japanese Patent Application Publication No. 2016-153658

Patent Literature 2: Japanese Patent Application Publication No. 2005-299807

### SUMMARY OF LNVENTION

### TECHNICAL PROBLEM

In the first strategy, when the clearance changes due to wear or the like of the sliding bearing, desired vibration suppression performance cannot be achieved. In the second strategy, as a result of attaching an accessory component (damper pulley) having a special structure, the weight of the entire reciprocating engine will increase, thereby worsening the fuel economy. Further, since the number of components constituting the reciprocating engine increases, the reliability will deteriorate. In short, in the conventional strategies, it is not possible to sufficiently suppress the vibration of crankshaft by a simple configuration.

It is an object of the present disclosure is to provide a crankshaft that can sufficiently suppress vibration by a simple configuration.

### SOLUTION TO PROBLEM

The crankshaft according to an embodiment of the present disclosure is a crankshaft for a reciprocating engine. The crankshaft includes: a plurality of journals which are disposed coaxially with a rotational center of the crankshaft; a plurality of pins which are decentered with respect to the plurality of journals; and a plurality of crank arms which are each disposed between one journal and one pin, and join the one journal with the one pin. One or more of the crank arms integrally include a counterweight including two side surfaces each of which is provided with a quenched layer.

### ADVANTAGEOUS EFFECTS OF INVENTION

According to the crankshaft of an embodiment of the present disclosure, it is possible to sufficiently suppress vibration by a simple configuration.

### BRIEF DESCRIPTION OF DRAWINGS

FIG. 1 is a side view to show an example of a typical crankshaft.

FIG. 2 is a side view to show another example of a typical crankshaft.

FIG. 3 is a perspective view of a crankshaft assumed in an examination step 1 by the present inventors.

FIG. 4 is a side view of the crankshaft shown in FIG. 3.

FIG. 5 is a side view of an arm with weight in the crankshaft shown in FIG. 3.

FIG. 6 is a front view of the arm with weight shown in FIG. 5.

FIG. 7 is a diagram to summarize analysis results in the examination step 1.

FIG. 8 is a front view of the arm with weight in the crankshaft assumed in the examination step 2 by the present inventors.

FIG. 9 is an enlarged view of a part of the firm with weight shown in FIG. 8.

FIG. 10 is a diagram to summarize the analysis results in the examination step 2.

FIG. 11 is a front view of the arm with weight in the crankshaft of an embodiment.

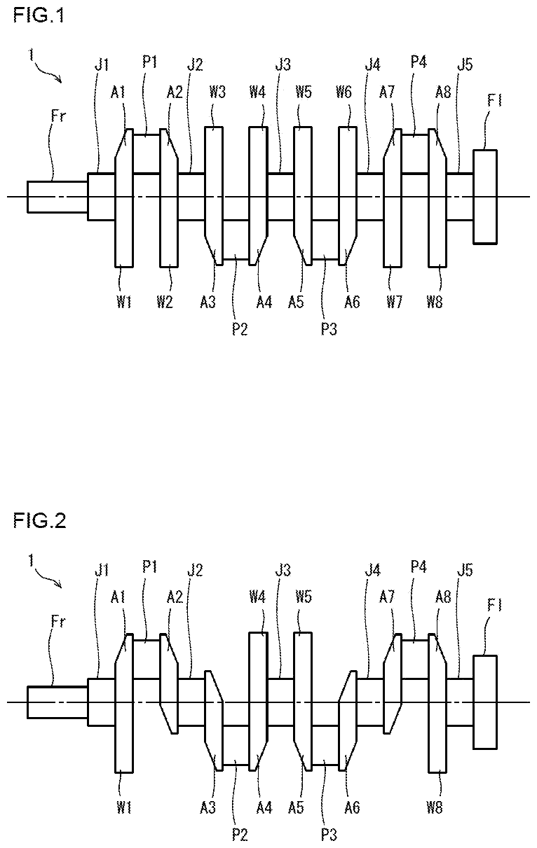

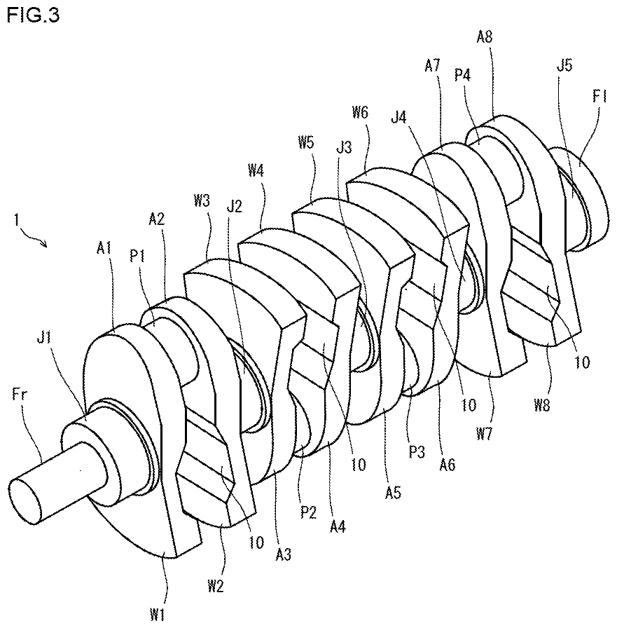

### DESCRIPTION OF EMBODLMENTS

To solve the above described problems, the present inventors have focused on the crankshaft itself instead of the accessory components attached to the crankshaft. Moreover, they have conducted diligent examination focusing on the weight in an arm with weight. As a result, they have obtained the following findings.

Generally, a crankshaft is made of carbon steel. The pins and journals slide with sliding bearings, respectively. To ensure wear resistance of the pin and the journal, the surfaces of the pin and the journal may be occasionally hardened by induction hardening. On the other hand, an arm is a part that guarantees the rigidity of the crankshaft, and appropriate strength and toughness are required for the arm. To ensure strength and toughness, generally, the steel microstructure of the arm is a pearlite structure or a mixed structure of ferrite structure and pearlite structure (ferrite+pearlite structure). In the present description, the pearlite structure and the ferrite+pearlite structure are collectively referred to as a normal structure as well.

The weight is a portion for balancing the rotation of the crankshaft and the mass itself of the weight is crucial. That is, the steel microstructure of the weight is not crucial in the essential function of the crankshaft. Therefore, in a conventional crankshaft, there has been no special consideration at all regarding the steel microstructure of the weight. Therefore, in a conventional crankshaft, the steel microstructure of the weight is the normal structure, the same as that of the arm.

Unless induction hardening is performed, the steel microstructure of each of the pin and the journal is the normal structure. Besides, the steel microstructure of each of the front part and the flange part is the normal structure as well.

Where, steels having different steel microstructures have different material constants such as Young's modulus even if they have the same chemical composition, This is shown in, for example, “Elastic constants and internal friction of martensitic steel, ferritic-pearlitic steel, and α-iron,” Materials Science and Engineering A, vol. 452-453, (2007) pp. 633-639. This literature describes that regarding SAE 1050 steel (a kind of carbon steel), a martensitic structure has a Young's modulus of 203.5 GPa and a Poisson's ratio of 0.2921, and a ferrite+pearlite structure has a Young's modulus of 210.3 GPa and a Poisson's ratio of 0.2877.

As described above, in a conventional crankshaft, the steel microstructure of the weight is the normal structure all over. In contrast to this, it is assumed that not only a portion of the normal structure, but also a portion of a steel microstructure. different from the normal structure (hereinafter, also referred to as a “heterostructure”) exists in the weight. The heterostructure is a martensite structure or a bainite structure obtained by quenching. In this case, it is presumed that the following situation occurs.

A crankshaft is a one body. Therefore, when the crankshaft vibrates as the crankshaft rotates, the weight vibrates and deforms. In this case, the portion of the heterostructure deforms following the deformation of the portion of the normal structure. As described above, the material constants of a portion of the heterostructure are different from those of a portion of the normal structure. Therefore, the easiness of deformation is different between the portion of the heterostructure and the portion of the normal structure. Then, when the weight vibrates and deforms, a force acts on the portion of the heterostructure and the portion of the normal structure to inhibit deformation of each other. Since the energy of vibration is dissipated by this force, the vibration is efficiently damped. Therefore, the vibration of the crankshaft is suppressed.

To confirm the validity of the above described presumption, the following examination has been conducted.

[Examination Step 1]

In the examination step 1, the level of vibration when a quenched layer having a martensite structure was provided in the weight was investigated. This investigation was performed by vibration analysis using a finite element method (FEM). In the analysis of the examination step 1, one or more surfaces were selected from the bottom surface and the two side surfaces of the weight, and the range of quenching to be applied to each selected surface was variously changed.

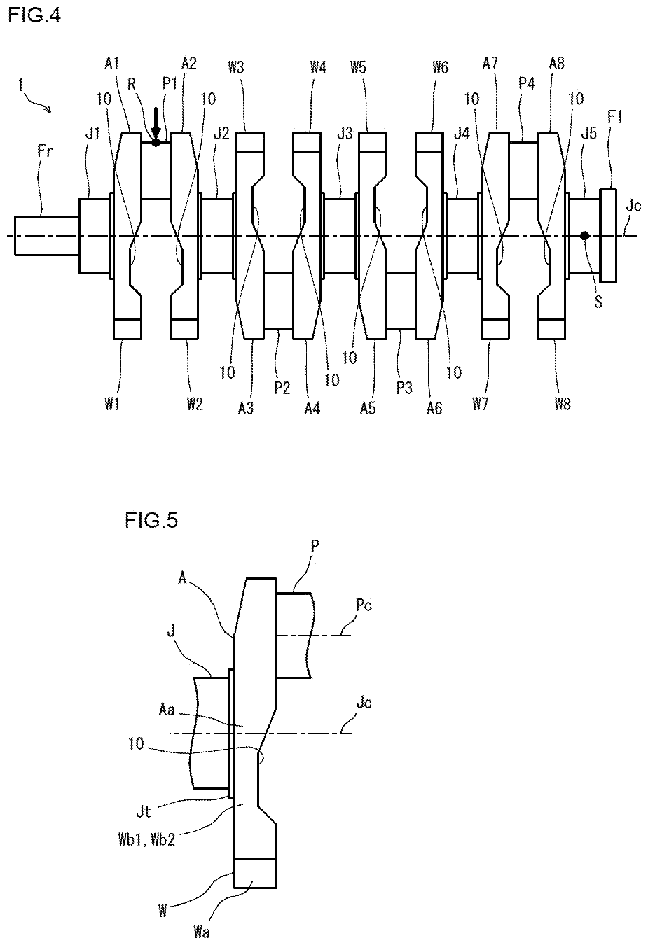

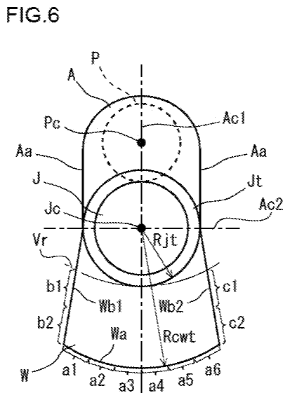

FIGS. 3 to 6 are diagrams showing the crankshaft which was assumed in the examination step 1. Among those figures, FIG. 3 is a perspective view of the crankshaft, and FIG. 4 is a side view of the crankshaft. FIG. 5 is a side view of an arm with weight in the crankshaft, and FIG. 6 is a front view of the arm with weight. In the present description, in an arm with weight, the face to which the journal J is connected is referred to as a front face, and the face opposite thereto, that is, the face. to which the pin P is connected, is referred to as a rear face. Note that FIG. 6 shows a longitudinal centerline Ac1 and a lateral centerline Ac2 of the arm A. In the present description, the longitudinal centerline Ac1 of the arm A is a straight line perpendicular to the axial centerline Jc of the journal J and the axial centerline Pc of the pin P, and the lateral centerline Ac2 is a straight line orthogonal to the longitudinal centerline Ac1 and the axial centerline Jc of the journal J. In the arm with weight, the direction in which the lateral centerline Ac2 extends is referred to as a width direction.

Referring to FIGS. 3 and 4, the crankshaft I assumed in the examination step 1 is a crankshaft of 4-cylinder 8-counterweight. The crankshaft 1 includes a plurality of journals J1 to J5, a plurality of pins P1 to P4, and a plurality of arms A1 to A8 as does a typical crankshaft (FIG. 1). The journals J1 to J5 are coaxially disposed with the rotational center of the crankshaft 1. Each of the pins P1 to P4 is disposed to be decentered with respect to the journals J1 to J5. Each of the arms A1 to A8 is deposed between one of the journals J1 to J5 and one of the pins P1 to P4 to connect the journal with the pin. The arms A1 to A8 integrally include weights W1 to W8, respectively.

As shown in FIG. 5, in the analysis model of the crankshaft 1, a concave thinned part 10 is formed in the rear face of the weight W of the arm A with weight W. The thinned part 10 is formed over the entire width of the weight W, expanding to the two side surfaces Wb1 and Wb2 of the weight W. This thinned part 10 is fanned across the weight W and the arm A. For this reason, the thinned part 10 also extends over to the rear face and the two side surfaces Aa of the arm A.

The weight of the arm A with weight W of the examination step 1 is significantly reduced by the thinned part 10. However, the shape of the weight W has almost no effect on supporting rigidity of the arm A with weight W. For that reason, the supporting rigidity of the arm A with weight W of the examination step 1 hardly decreases. Therefore, in the case of the crankshaft 1 including the arm A with weight W having the thinned part 10, a significant weight reduction can be expected. In the present description, the supporting rigidity means deformation resistance of the arm A when a load is applied to the pin P.

Referring to FIG. 6, in the arm A with weight W, the arm A and the weight W are sectioned by a plane including the lateral centerline Ac2 and the axial centerline Jc of the journal J. That is, out of the arm A with weight W, a portion located on the pin P side is the arm A, and a portion located on the opposite side of the pin P is the weight W with a plane including the lateral centerline Ac2 and the axial centerline Jc of the journal J being as a boundary. In the present description, the convenience of explanation, of the arm A with weight W, the arm. A side is referred to as an upper side, and the weight W side is referred to a lower side.

The side surface Aa of the arm A and the side surfaces Wb1 and Wb2 of the weight W extend substantially in the vertical direction. The side surfaces Wb1 and Wb2 of the weight W extend outwardly in the width direction toward downward. The side surfaces Wb1 and Wb2 are connected by a bottom surface Wa. The bottom surface Wa has an arc shape centered on the axial centerline Jc of the journal J in a front view of the arum A with weight W. In the present description, the surface between the side surfaces Wb1 and Wb2 is referred to as a bottom surface Wa because the weight W side is defined as: the lower side in the arm A with weight W for convenience however, the bottom surface Wa of the weight W is not always located on the lower side in an actual crankshaft.

As shown in FIG. 6, the crankshaft 1 assumed in the examination step 1 has a thrust (hereinafter, also referred to as a “journal thrust”) Jt around the journal J. The journal thrust Jt has an annular shape centered on the axial centerline Jc of the journal J in a front view of the arm A with weight W. The journal thrust Jt restricts the movement of the journal J in the direction in which the axial centerline Jc extends (axial direction). That is, in the reciprocating engine, the movement of the journal J in the axial direction is limited by the contact between the journal thrust Jt and the sliding bearing attached to the engine block (not shown).

FIG. 6 shows a portion where the quenched layer is provided in the examination step 1. As described above, the bottom surface Wa of the weight W has an arc shape centered on the axial centerline Jc of the journal J in a front view of the arm A with weight W. The symbol Rcwt in FIG. 6 indicates the radius of the bottom surface Wa. The journal thrust Jt has an annular shape centered on the axial centerline Jc of the journal J in a front view of the arm A with weight W. The symbol Rjt indicates the radius of the journal thrust Jt.

A quenched layer is provided in one or more surfaces of the bottom surface Wa and the two side surfaces Wb1 and Wb2 of the weight W. The bottom surface Wa of the weight W is sectioned into six regions a1 to a6 in a direction along the bottom surface Wa as a unit in which a quenched layer is provided. The six regions a1 to a6 are successively lined up from one end to the other end of the bottom surface Wa. Each of the six regions a1 to a6 has the same length along the bottom surface Wa.

As the unit in which the quenched layer is provided, one side surface Wb1 of the weight W is sectioned into two regions b1 and b2 to in a direction along the side surface Wb1 (longitudinal direction of the side surface Wb1). With an intersection point between the arc Vt indicated by a two-dot chain line in FIG. 6 and the side surface Wb1 in a front view of the aim A with weight W as a starting point, the two regions b1 and b2 are successively lined up from the intersection point to the bottom surface Wa of the weight W. The arc Vr is a virtual arc which has the same radius Rcwt as that of the bottom surface Wa in a front view of the Arm A with weight W, and passes through the lower end (the end of the weight W side) of the journal thrust Jt. The center of the Arc Vr is located on the longitudinal centerline Ac1. Each of the two regions b1 and b2 has the same length along the side surface Wb1. The length along the side surface Wb1 of each of the two regions b1 and b2 is approximately (Rcwt−Rjt)/2. Similarly, the other side surface Wb2 of the weight W is sectioned into two regions c1 and c2 in a direction along the side surface Wb2 (the longitudinal direction of the side surface Wb2).

In the analysis of the examination 1, one or more surfaces were variously selected from the bottom surface Wa and the two side surfaces Wb1 and Wb2 of the weight W. Further, one or more regions were variously selected from a plurality of regions a1 to a6, b1, b2, c1, and c2 in the selected surface quenching was performed on the selected region to form a quenched layer having a martensite structure (heterostructure). The thickness (depth) of the quenched layer was 1 mm. The steel microstructure of the portion other than the quenched layer of the weight W was a non-quenched ferrite+pearlite structure (normal structure). Table 1 below shows the installation pattern of the quenched layer of arm A with weight W investigated in the examination step 1.

TABLE 1

| | Side surface | | Outer peripheral surface | | | | | | Side surface | |
|---|---|---|---|---|---|---|---|---|---|---|
| Model No. | b1 | b2 | a1 | a2 | a3 | a4 | a5 | a6 | c2 | c1 |
| A1 | M | M | M | M | M | M | M | M | M | M |
| A2 | M | M | | | | | | | M | M |
| A3 | M | | | | | | | | | M |
| A4 | | M | | | | | | | M | |
| B1 | | | M | M | | | | | | |
| B2 | | | M | M | M | | | | | |
| B3 | | | | M | M | | | | | |
| C1 | | | | | M | M | | | | |
| C2 | | | M | M | M | M | M | M | | |
| Base | | | | | | | | | | |
| D1 | M | M | | | | | | | | |
| D2 | | | | | M | | | | | |

(Remarks)
Symbol “M” indicates a portion of quenched layer which has a martensite structure by quenching.
Blank column indicates a portion of non-quenched ferrite + pearlite structure.

On a plurality of models of crankshafts each including an arm with weight, quenched layers are provided in the weight according to the installation pattern shown in Table 1 described above to investigate accelerance (inertance). The “accelerance” indicates a value obtained by a frequency analysis to evaluate an acceleration waveform at an observation point when a striking force (impulse excitation force) is applied, and then to divide the vibration acceleration by the excitation force for each frequency. Decrease in the accelerance means smaller vibration acceleration generated in response to the same vibration input. That is, decrease in the accelerance means that vibration could be suppressed. Therefore, comparing the accelerance of each model enables to evaluate the suppression of vibration.

Here, in the case of a crankshaft, journals of the crankshaft are each supported by a sliding bearing attached to the engine block. Thereby, the crankshaft is connected to the engine body. Therefore, to suppress the vibration of a reciprocating engine, it is necessary to suppress the vibration of the journals of the crankshaft.

As a vibration source to be inputted to the crankshaft, explosion load when explosion occurs in a cylinder is considered. The explosion load is transmitted to the piston, and further transmitted from the piston to the con-rod via the piston pin. The load transmitted to the con-rod is inputted to the pin of the crankshaft, Therefore, the pin mainly serves as the vibration source of the crankshaft. Therefore, the accelerance at the center of the Journal when the surface of the pin was struck was evaluated.

Specifically, referring to FIG. 4, a striking force was inputted to a point R of the first pin P1. The point R was a point located at the center of the first pin P1 in the axial direction and at the top of the first pin P1. The striking force was applied in a direction toward the axial centerline Jc of the journal J. With respect to the input of the striking force, the acceleration generated at a point S of the fifth journal J5 was determined. The point S is a point located at the axial center of the fifth journal J5 and on the axial centerline Jc of the fifth journal J5. The acceleration to be obtained was acceleration in a direction along the input direction of the striking force.

The obtained acceleration was divided by the striking force, and thereafter was subjected to frequency analysis to determine an acceleration amplitude in a range of 1 Hz to 2500 Hz to obtain frequency characteristics of accelerance. A maximum value of the accelerance was determined from the obtained frequency characteristics of accelerance.

Note that in vibration analysis, the Young's modulus was 203.5 GPa and the Poisson's ratio was 0.2921 in a portion of the quenched layer (martensite structure). And in a portion of a ferrite+pearlite structure other than the quenched layer, the Youngs modulus was 210.3 GPa and the Poisson's ratio was 0.2877.

For a plurality of models of crankshaft each having an arm with weight, a quenched layer was provided in the weight according to the installation patterns shown in Table 1 described above, and vibration analysis as described above was performed for each model. Then, the maximum values of the accelerance obtained by the vibration analysis of each model were compared and evaluated. The evaluation was performed based on a ratio (accelerance ratio) to the maximum value of accelerance in the base model having no quenched layer in the weight. If the accelerance ratio is less than 1, it can be said that vibration can be suppressed. Further, it can be said that the smaller the accelerance ratio, the more effectively the vibration can be suppressed. On the other hand, if the accelerance ratio is more than 1, it can be said that Vibration cannot be suppressed.

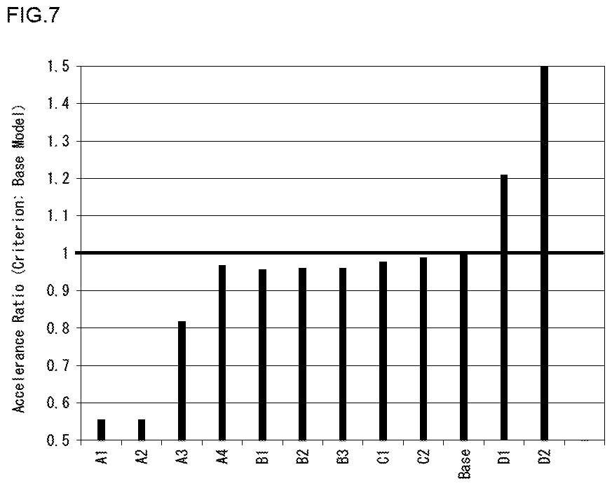

FIG. 7 is a diagram summarizing the analysis results in the examination step 1. The reference symbols shown on the horizontal axis of. FIG, 7 correspond to Model Nos. shown in Table 1. The followings are indicated from the results of FIG. 7. From the comparison between Model Nos. A1 to A4 and the base model, vibration can be suppressed if the quenched layers are provided on both of the two side surfaces Wb1 and Wb2 of the weight W. In particular, if the length of the region of quenched layer along the side surface Wb1, Wb2 is 0.5 times or more of (Rcwt−Rjt) and the region of quenched layer is adjacent to the arm A, vibration is effectively suppressed (See Model Nos. A1 to A3). Further, if the length of the region of quenched layer along the side surface Wb1, Wb2 is one time or more of (Rcwt−Rjt), the vibration suppressing effect is particularly high (see Model Nos. A1 and A2).

In contrast to this, when a quenched layer is provided on only one of the two side surfaces Wb1 and Wb2 of the weight W, vibration cannot be suppressed (see Model No. D1). Further, even if a quenched layer is provided on the bottom surface Wa of the weight W, the vibration suppressing effect hardly occurs.

In short, vibration can be sufficiently suppressed only by providing quenched layers on both of the two side surfaces Wb1 and Wb2 of the weight W.

[Examination Step 2]

In the examination step 2, as in the examination step 1, the level of vibration when a quenched layer having a martensite structure was provided in the weight was investigated. In the analysis of the examination step 2, the range of the quenched layer provided on the two side surfaces of the weight was subdivided and variously changed. Other conditions were the same as those in the examination step 1.

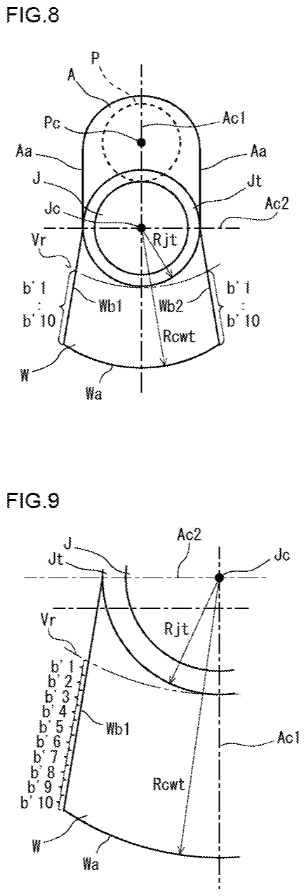

FIG. 8 and FIG. 9 are diagrams showing an arm with weight in the crankshaft assumed in the examination step 2. Among these figures, FIG. 8 is a front view of the arm with weight, and FIG. 9 is an enlarged view of a part of the weight of the arm with weight shown in FIG. 8.

FIG. 9 shows portions where the quenched layer is provided in the examination step 2. As a unit in which the quenched layer is provided, one side surface Wb1 of the weight W is sectioned into ten regions b′1 to b′10 in a direction along the side surface Wb1. The ten regions b′1 to b′10 are successively lined up from the intersection point between the arc Vr and the side surface Wb1 to the bottom surface Wa of the weight W m a front view of the arm A with weight W. The length along the side surface Wb1 of each of the ten regions b′1 to b′10 is the same. The length along the side surface Wb1 (the length in the longitudinal. direction of the side surface Wb1) of each of the ten regions b′1 to b′10 is substantially (Rcwt−Rjt)/10. Similarly, the other side surface Wb2 of the weight W is sectioned into ten regions (not shown) in a direction along the side surface Wb2.

In the analysis of the examination step 2, both of the two side surfaces Wb1 and Wb2 of the weight W were selected as the surface to be quenched. Further, one or more regions were variously selected from the ten regions b′1 to b′10 in one side surface Wb1 as the region where a quenched layer was provided. In the other side surface Wb2, a region which was symmetrical to the region selected in the side surface Wb1 with respect to the longitudinal centerline Ac1 of the arm A was selected. Quenching was performed on the selected region to form a quenched layer having a martensite structure (heterostructure). The steel microstructure of portions other than the quenched layer of the weight W was a non-quenched ferrite+pearlite structure (normal structure). Table 2 below shows the installation patterns of quenched layer in a plurality of models of arm A with weight W investigated in the examination step 2.

TABLE 2

| Model No. | b′1 | b′2 | b′3 | b′4 | b′5 | b′6 | b′7 | b′8 | b′9 | b′10 |
|---|---|---|---|---|---|---|---|---|---|---|
| Base | | | | | | | | | | |
| A′1 | M | | | | | | | | | |
| A′2 | | M | | | | | | | | |
| A′3 | | | M | | | | | | | |
| A′4 | | | | M | | | | | | |
| A′5 | | | | | M | | | | | |
| A′6 | | | | | | M | | | | |
| A′7 | | | | | | | M | | | |
| A′8 | | | | | | | | M | | |
| A′9 | | | | | | | | | M | |
| A′10 | | | | | | | | | | M |
| B′1 | M | M | | | | | | | | |
| B′2 | | M | M | | | | | | | |
| B′3 | | | M | M | | | | | | |
| B′4 | | | | M | M | | | | | |
| B′5 | | | | | M | M | | | | |
| B′6 | | | | | | M | M | | | |
| B′7 | | | | | | | M | M | | |
| B′8 | | | | | | | | M | M | |
| B′9 | | | | | | | | | M | M |
| C′1 | M | M | M | | | | | | | |
| C′2 | | M | M | M | | | | | | |
| C′3 | | | M | M | M | | | | | |
| C′4 | | | | M | M | M | | | | |
| C′5 | | | | | M | M | M | | | |
| C′6 | | | | | | M | M | M | | |
| C′7 | | | | | | | M | M | M | |
| C′8 | | | | | | | | M | M | M |
| D′1 | M | M | M | M | | | | | | |
| D′2 | | M | M | M | M | | | | | |
| D′3 | | | M | M | M | M | | | | |
| D′4 | | | | M | M | M | M | | | |
| D′5 | | | | | M | M | M | M | | |
| D′6 | | | | | | M | M | M | M | |
| D′7 | | | | | | | M | M | M | M |
| E′1 | M | M | M | M | M | | | | | |
| E′2 | | M | M | M | M | M | | | | |
| E′3 | | | M | M | M | M | M | | | |
| E′4 | | | | M | M | M | M | M | | |
| E′5 | | | | | M | M | M | M | M | |
| E′6 | | | | | | M | M | M | M | M |
| F′1 | M | M | M | M | M | M | | | | |
| F′2 | | M | M | M | M | M | M | | | |
| F′3 | | | M | M | M | M | M | M | | |
| F′4 | | | | M | M | M | M | M | M | |
| F′5 | | | | | M | M | M | M | M | M |
| G′1 | M | M | M | M | M | M | M | | | |
| G′2 | | M | M | M | M | M | M | M | | |
| G′3 | | | M | M | M | M | M | M | M | |
| G′4 | | | | M | M | M | M | M | M | M |
| H′1 | M | M | M | M | M | M | M | M | | |
| H′2 | | M | M | M | M | M | M | M | M | |
| H′3 | | | M | M | M | M | M | M | M | M |
| I′1 | M | M | M | M | M | M | M | M | M | |
| I′2 | | M | M | M | M | M | M | M | M | M |
| J′1 | M | M | M | M | M | M | M | M | M | M |

(Remarks)
Symbol “M” indicates a portion of quenched layer which has a martensite structure by quenching.
Blank column indicates a portion of non-quenched ferrite + pearlite structure.

For a plurality of models of crankshaft each including an arm with weight, a quenched layer was provided in the weight according to the installation patterns shown in Table 2 described above, and vibration analysis was performed for each model in the same manner as in the examination step 1. Then, the maximum values of accelerance obtained by the vibration analysis of each model were compared and evaluated. The evaluation was performed based on a ratio (accelerance ratio) to the maximum value of accelerance in the base model having no quenched layer in the weight.

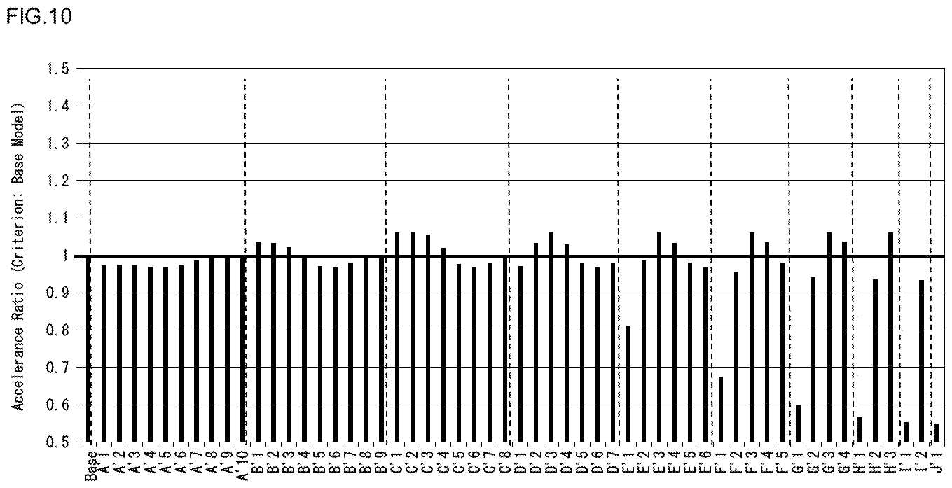

FIG. 10 is a diagram summarizing the analysis results in the examination step 2. The reference symbols shown on the horizontal axis of FIG. 10 correspond to Model Nos. shown in Table 2. The followings are indicated from the results of FIG. 10. If the length of the region of quenched layer along the side surface Wb1, Wb2 is 0.5 times or more of (Rcwt−Rjt), vibration may be occasionally effectively suppressed (see Model Nos. E′ to J′). In this case, if the quenched layer is provided closer to the journal thrust Jt, vibration can be suppressed more effectively (see Model Nos. E′1, F′1, G′1, H′1, I′1, and J′1). Further, if the length of the region of quenched layer along the side surface Wb1, Wb2 is 0.9 times or more of (Rewt−Rjt), the vibration suppressing :effect is high (see Model Nos. I′ to J′). From this, it is considered that if the quenched layer is provided in the whole area of the side surface Wb1, Wb2 of the weight W, higher vibration suppression effect can he achieved.

In contrast to this, if the length of the region of quenched layer along the side surface Wb1, Wb2 is 0.4 times or less of (Rcwt−Rjt), significant vibration suppression effect is not recognized.

The crankshaft of the present disclosure has been completed based on the above described findings.

A crankshaft according to an embodiment of the present disclosure includes a plurality of journals, a plurality of pins, and a plurality of crank arms. The plurality of journals are disposed coaxially with the rotational center of the crankshaft. The plurality of pins are decentered with respect to the plurality of journals. The plurality of crank arms are each disposed between one journal and one pin, and join the one journal with the one pin. One or more of the crank arms integrally include a counterweight. The counterweight includes two side surfaces. These two side surfaces are provided with quenched layers.

According to the crankshaft of the present embodiment, a quenched layer is provided on both of the two side surfaces of the weight. The steel microstructure of this quenched layer is a martensite structure or a bainite structure. The steel microstructure of portions other than the quenched layer in the arm with weight is a ferrite+pearlite structure or a pearlite structure. Providing a quenched layer having the heterostructure only in the two side surfaces of the weight makes it possible to sufficiently suppress the vibration generated in the crankshaft. In the weight, it is preferable that a quenched layer is not provided in the bottom surface connecting the side surfaces. Normally, when the rotational balance of crankshaft is adjusted, drilling is performed on the bottom surface of the weight. When there is no hard quenched layer in the bottom surface of the weight, there is no problem with the drilling.

The method for forming a quenched layer is not particularly limited. For example, a quenched layer can be formed by induction hardening. Besides, a quenched layer can be formed by flame quenching or laser quenching. Electric heating may be applied as the heating method. When the crankshaft is produced by hot forging, only the side surfaces of the weight may be water-cooled in the cooling stage.

The thickness (depth) of the quenched layer is not particularly limited. However, practically, the thickness of the quenched layer is about 0.5 to 10 mm. As a typical example, when a quenched layer is formed by induction hardening, the thickness of the quenched layer is about 0.5 to 2 mm.

In a typical example, the crankshaft of the present embodiment is a crankshaft of 4-cylinder 8-counterweight or a crankshaft of 4-cylinder 4-counterweight. However, the crankshaft of the present embodiment will not be limited to this type. For example, the crankshaft of the present embodiment may be a crankshaft for a three-cylinder engine or a crankshaft for an in-line six-cylinder engine.

The number of the arms with weight in which a quenched layer is provided is not particularly limited. When the crankshaft has a plurality of arms with weight, a quenched layer may be provided in one arm with weight, or a quenched layer may be provided in two or more arms with weight, or a quenched layer may be provided in all the aims with weight. From the viewpoint of maximally reducing the vibration generated in the crankshaft, it is preferable to provide a quenched layer in all the arms with weight.

In a typical example, the region where the quenched layer is provided on one side surface of a weight is symmetrical with respect to the region where the quenched layer is provided on the other side surface of the weight with respect to the longitudinal centerline of the arm. However, the regions of quenched layer in both side surfaces of the weight may be asymmetric with respect to the longitudinal centerline of the arm. The shape of the arm with weight, although which is typically symmetric with respect to the longitudinal centerline of the arm, may also be asymmetric.

A thinned part may or may not he formed in the arm with weight. However, from the viewpoint of reducing the weight of the crankshaft, it is preferable that a thinned part is formed in the arm with weight.

In the crankshaft of the present embodiment, it is preferable that quenched layer is provided in the whole area of the side snake of the counterweight. This makes it possible to particularly effectively suppress the vibration of crankshaft.

In the crankshaft of the present embodiment, the quenched layer may be provided in a part of each side surface of the counterweight. In this case, when the radius of the bottom surface of the counterweight is defined as Rcwt and the radius of the thrust of the journal is defined as Rjt, the length of the quenched layer in the longitudinal direction of each side surface of the counterweights preferably 0.5 times or more of (Rcwt−Rjt), The length of the quenched layer is preferably 0.6 times or more of (Rcwt−Rjt), and more preferably 0.9 times or more of (Rcwt−Rjt). This makes it possible to effectively suppress the vibration of crankshaft.

When the quenched layer is provided on a part of the side surface of the counterweight, the quenched layer is preferably provided in a region closer to the thrust of the journal. This makes it possible to more effectively suppress the vibration of crankshaft.

Hereinafter, referring to the drawings, a specific example of the crankshaft of the present embodiment will he described.

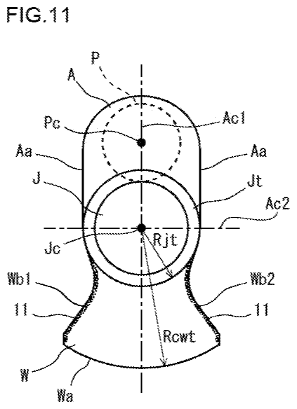

FIG. 11 is a front view of an arm with weight in the crankshaft of the present embodiment. The arm A with weight W shown in FIG. 11 can be applied to all of the eight arms with weight provided in the crankshaft of for example, 4-cylinder 8-counterweight.

Referring to FIG. 11, the shape of the aim A with weight W is symmetric with respect to the longitudinal centerline Ac1 of the arm A. The weight W has a constricted part and is widened from the constricted part toward the bottom surface. Wa in a front view of the arm A with weight W. That is, the width of the weight W is smaller on the journal thrust Jt side and larger on the bottom surface Wa side. The weight W has a maximum width at the lower end of the side surface Wb1, Wb2 (the end on the bottom surface Wa side). A quenched layer 11 is provided on the whole area of each of the two side surfaces Wb1 and Wb2 of the weight W. That is, the quenched layer 11 is provided in the entire range of the side surfaces Wb1 and Wb2 from the lateral centerline Ac2 side of the arm A to the bottom surface Wa side of the weight W in a front view of the arm A with weight W. The quenched layer 11 is provided in the weight W so as to have a predetermined thickness (depth) from each of the side surfaces Wb1 and Wb2. This quenched layer 11 is formed by, for example, induction hardening. The steel microstructure of the quenched layer 11 is, for example, a martensite structure. The steel microstructure of portions other than the quenched layer 11 in the arm A with weight W is, for example, a ferrite+pearlite structure. According to the crankshaft including such arm A with weight W, the vibration generated in the crankshaft can be sufficiently suppressed.

In addition, it is needless to say that the present disclosure is not limited to the above described embodiments, and various alterations can be made without departing from the spirit of the present disclosure.

### INDUSTRIAL APPLICABILITY

The present disclosure can be effectively used for a crankshaft mounted on. any reciprocating engine.

### REFERENCE SIGNS LIST

1: Crankshaft

J, J1 to J5: Journal

Jc: Axial centerline of journal

Jt: Thrust of journal

P, P1 to P4; Pin

Pc: Axial centerline of pin

A, A1 to A8: Crank arm

Aa: Side surface of crank arm

Ac1: Longitudinal centerline of anti

Ac2: Lateral centerline of arm

W, W1 to W8: Counterweight

Wa: Bottom surface of counterweight

Wb1, Wb2: Side surface of counterweight

11: Quenched layer

1. A crankshaft for a reciprocating engine, the crankshaft comprising:
a plurality of journals which are disposed coaxially with a rotational center of the crankshaft;
a plurality of pins which are decentered with respect to the plurality of journals; and
a plurality of crank arms which are each disposed between one journal and one pin, and join the one journal with the one pin, wherein
one or more of the crank arms integrally include a counterweight including two side surfaces each of which is provided with a quenched layer.

2. The crankshaft according to claim 1, wherein
the quenched layer is provided in a whole area of the side surface the counterweight.

3. The crankshaft according to claim 1, wherein
the counterweight further includes:
a bottom surface having an arc-shape centered on an axial centerline of the journals, and connecting the two side surfaces, and wherein
when a radius of the bottom surface is defined a Rcwt, and a radius of a thrust of the journal is defined as Rjt, a length of the quenched layer in a longitudinal direction of the side surface is 0.5 times or more of (Rcwt−Rjt).

4. The crankshaft according to claim 3, wherein
the quenched layer is provided in a region closer to the thrust in the side surface of the counterweight.
